(19) United States
(12) Patent Application Publication
(10) Pub. No.: US 2007/0220460 A1
(43) Pub. Date: Sep. 20, 2007

(54) Method for verifying line information in a layout and system thereof

(76) Inventors: Yu-Chuan Chang, Taipei (TW); Yi-Hsin Hsieh, Taipei (TW); Yung-Chien Cheng, Taipei (TW)

Correspondence Address: HARNESS, DICKEY & PIERCE, P.L.C., P.O. BOX 8910, RESTON, VA, 20195, US

(21) Appl. No.: 11/374,964

(22) Filed: Mar. 15, 2006

(51) Int. Cl. G06F 17/50

(52) U.S. Cl. 716/5

(57) ABSTRACT

A method for verifying line information in a layout and system thereof are provided. The verification method comprises obtaining and arranging a line data to classify the types of the line data; generating a corresponding line information record file after the line data is classified; sending a message appended with the line information record file to a user; confirming the types of the line data once again according to the line information record file by the user; directly modifying the line information record file by the user when it has been confirmed that the line data is wrong; and importing the modified line information record file into the line information database, so as to update the data in the line information database, thereby improving the accuracy of data.

### BACKGROUND OF THE INVENTION

1. Field of Invention

The present invention relates to a data verification method and system thereof, and more particularly to a method for verifying line information in a layout and system thereof.

2. Related Art

During the design of the printed circuit board, previous computer graphic design is one of the important works, wherein the operation of computerizing the printed circuit board mainly comprises two parts, including a preplacement operation, and a subsequent layout operation. A part of the line data, used in the line layout, is created by the electronic engineer enduing each line with the related information (for example, line width, line length, line type and the like), and the line data are stored in the line information database for use in the later line layout. However, the greater part of the line data are provided by manufacturer. The names or serial numbers of lines defined by each manufacturer are different from each other, such that the line data should be classified by the electronic engineer before being stored in the line information database. The classifying step substantially comprise first creating a sub group; classifying the lines of the same type having different line names into the same sub group; then directing the sub group to the corresponding line type. As such, the line name can correspond to the line type, and the line data are stored into the line information database. However, during the classification of new line names by the electronic engineer, some line data might be neglected or classified into the wrong sub group due to careless human error. Sometimes, the line data have already been applied in multiple types of machines when the line data is found to be wrong, thus the line data should be modified again, which is extremely time consuming and inefficient.

Referring to ROC patent publication No. 200408997, an order recheck system under electronic data exchange environment is disclosed, which comprises an electronic data exchange server, a message conversion server, an order management server, an order management system, and an order recheck system. The electronic data exchange server is used for receiving an electronic data exchange message, and sending the electronic data exchange message to the message conversion server to convert the electronic data exchange message into a first electronic order file, and sending the first electronic order file to the order management system. The order recheck system is used for cutting the electronic data exchange message into a second electronic order file, and comparing the first electronic order file and the second electronic order file. If the number of the first electronic order file is different from that of the second electronic order file, or at least one serial number is different, an alarm message is sent. The above system can solve the problem that error occurs when sending and exchanging the electronic data, however, additional servers are needed to process the related data management and check operation, which increases the cost of electronic data management.

Therefore, it becomes one of the problems to be solved for the researchers how to provide a method for updating line information in a layout and system thereof to improve the accuracy of the data.

### SUMMARY OF THE INVENTION

In view of the above problem, a main object of the present invention is to provide a method for verifying line information in a layout and system thereof. The method is suitable for the user to check whether newly added line data are correct or not quickly through a double confirmation, and to directly modify and update the data when an error is found, thereby improving the accuracy of the data.

Therefore, in order to achieve the above object, the method for verifying line information in a layout disclosed in the present invention comprises the steps as follows. First, a system acquires a new line data and arranges the line data, to classify the types of the line data. A corresponding line information record file is generated after the line data is classified. Then, a message appended with the line information record file is sent to inform the user, wherein the inform message is sent to the user in email.

The user confirms whether the type of the line data is correct once again according to the line information record file. When having confirmed that the a line data is wrong, the user directly modifies the line information record file, and then imports the modified line information record file into the line information database, so as to update the data in the line information database.

In the step of generating a corresponding line information record file after the line data is classified, a step of importing the line data into the line information database is further provided.

Moreover, in order to achieve the above object, the system for verifying the line information in a layout disclosed in the present invention comprises a data editing interface, for users to input at least one line data and arrange the type of the line data; a record file generating unit, for generating a corresponding line information record file according to the arranged type of the line data, wherein the content of the line information record file contains a line name and a sub group name; a line information database, for storing one or more line data; and a data update unit, for updating the line data in the line information database according to the line information record file.

The user further examines whether the line data is correct through checking the content of the line information record file, and directly modifies the line information record file when the line data is wrong. And the data update unit further updates the line data in the line information database according to the modified line information record file. With the method for verifying line information in a layout and system thereof, a corresponding line information record file is generated according to the classified line data, for the user to make a second confirmation, and for the user to directly modify the line information record file when the line data is found to be wrong. And the line information record file is imported into the line information database to perform the updating operation. Therefore, careless human error will be reduced, and the accuracy of the data is improved.

The characteristics and practices related to the present invention will be described in detail by preferred embodiments in accompany with the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and which thus is not limitative of the present invention, and wherein:

FIG. 1 shows a flow chart of a method for verifying line information in a layout according to an embodiment of the present invention; and

FIG. 2 shows a block diagram of the system for verifying line information in a layout according to the embodiment of the present invention.

### DETAILED DESCRIPTION OF THE INVENTION

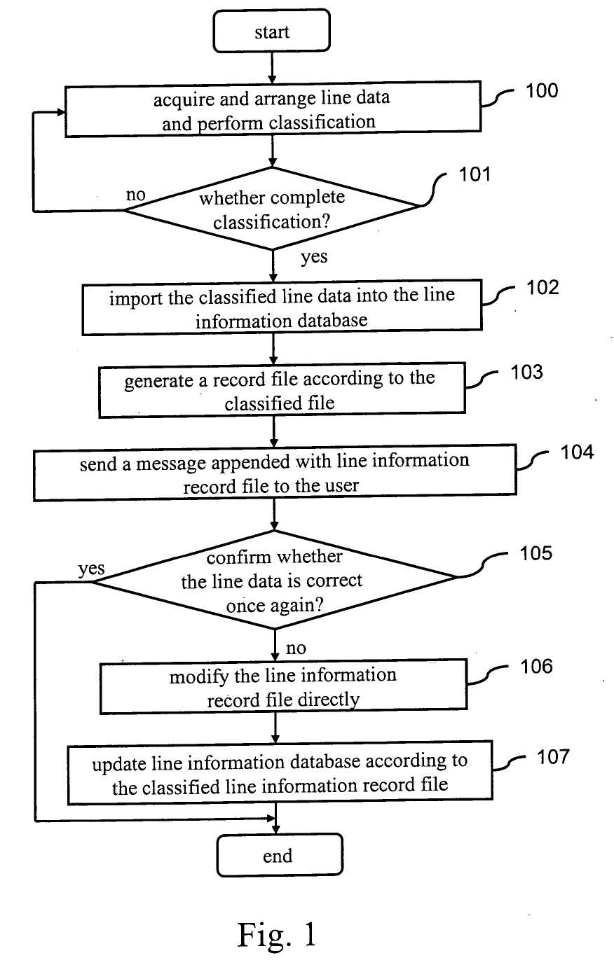

Referring to FIG. 1, it shows a flow chart of an embodiment of the present invention, which comprises reading a file containing newly added line data, and arranging and classifying the types of the line data (step 100). At this time, the user makes a first data input and confirmation.

Next, it is determined whether all newly added line data are classified (step 101). In practice, it can be determined by checking whether there is unclassified line data. When the classification is not finished, return to step 100 to continue classifying. When all newly added line data are classified, the newly added line data are imported and stored in the line information database 20 (step 102).

Next, a corresponding line information record file is generated according to the newly added line data (step 103). A message appended with the line information record file is sent to the user (step 104), wherein the message can be sent in email. The user confirms whether the content of the line data is correct once again according to the line information record file (step 105). At this time, the user makes a second line data confirmation.

After confirming the line data is wrong, the user directly modifies the content of the line information record file (step 106), and imports the line information record file into the data update unit 40 after modification, so as to update the data in the line information database 20 (step 107). When the user confirms that the line data is correct, the operation is complete.

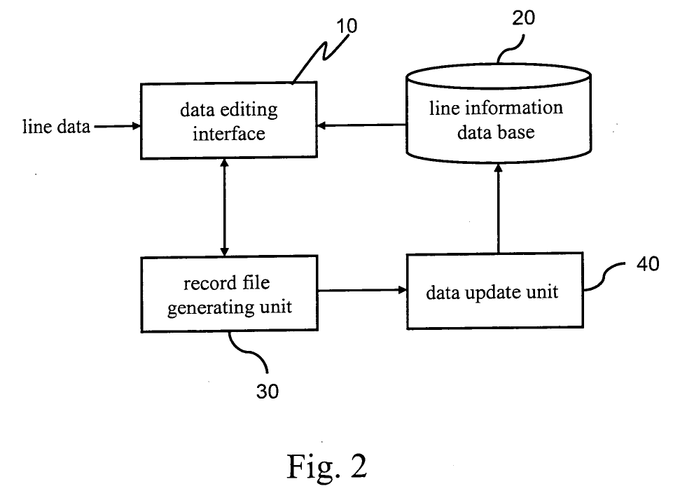

Referring to FIG. 2, it shows a block diagram of a line information updating system of the embodiment of the present invention, which comprises a data editing interface 10, a line information database 20, a record file generating unit, and a data update unit 40.

The data editing interface 10 is used for a user to input newly added line data, or to read a file containing newly added line data, wherein the operation window of the data editing interface 10 contains an “ADD” option and a “REMOVE” option, for the user to add/remove the line name into/from the sub group, thereby arranging and classifying the types of the line data.

The line information database 20, connected to the data editing interface 10, is used for storing one or more line data. Moreover, when the user input the line data, the line information database 20 provides the line data for the data editing interface 10 to read, so as to determine whether the data input by the user is the newly added line data or the old line data existed in the line information database 20. Thus, the user only needs to classify the newly added data, reducing the probability of the occurrence of the human error.

The record file generating unit 30, connected to the data editing interface 10, is used for generating a corresponding line information record file according to the type of the line data arranged by the user in the data editing interface 10, wherein the content of the line information record file contains the information about the corresponding sub group name of the line name, for example, “Net1 sub_group1”, in which “Net1” is the line name, and “sub_group1” is the line sub group name. Moreover, the record file generating unit 30 further sends a message appended with the line information record file to inform the user, wherein the message can be sent in email.

The data update unit 40, connected to the record file generating unit 30 and the line information database 20 respectively, is used for receiving the line information record file generated by the record file generating unit 30, and for updating the data in the line information database 20 according to the line information record file. And the line information record file after being modified by the user is also sent to the data update unit 40 to be processed, so as to reclassify the type of the line information. Thus, by only checking and examining the newly added part, the user can update the data in the line information database 20 quickly. Thus, the convenience of data modification is increased.

With the method for verifying line information in a layout and system thereof, a corresponding line information record file is generated according to the classified line data, for the user to make a second confirmation, and for the user to directly modify the line information record file when the line data is found to be wrong. And the line information record file is imported, into the line information database to perform the updating operation. Therefore, careless human error will be reduced, and thereby the accuracy of the data is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for verifying line information in a layout, for ensuring the accuracy in updating data in a line information database through examining the updated content of the data repeatedly, comprising:
obtaining and arranging a line data, to classify a type of the line data;
generating a corresponding line information record file after the line data is classified;
sending a message appended with the line information record file to inform a user;
confining the types of the line data once again according to the line information record file by a user;
modifying the line information record file by the user when having confirmed that the line data is wrong; and
importing the modified line information record file into the line information database to update the data in the line information database.

2. The method for verifying line information in a layout as claimed in claim 1, wherein the message is sent in email.

3. The method for verifying line information in a layout as claimed in claim 1, wherein the content of the line information record file at least comprises a line name and a sub group name.

4. The method for verifying line information in a layout as claimed in claim 1, wherein the step of generating a corresponding line information record file after the line data is classified further comprises importing the line data into the line information database.

5. A system for verifying the line information in a layout, comprising:
a data editing interface, for inputting at least one line data and arranging a type of the line data;
a record file generating unit, for generating a corresponding line information record file according to the types of the arranged line data;
a line information database, for storing one or more line data; and
a data update unit, for updating the line data in the line information database according to the line information record file;
wherein the user examines whether the line data is correct or not by checking the content of the line information record file, and directly modifies the line information record file when the line data is wrong.

6. The system for verifying the line information in a layout as claimed in claim 5, wherein the content of the line information record file at least comprises a line name and a sub group name.

7. The system for verifying the line information in a layout as claimed in claim 5, wherein the record file generating unit is used for further informing the user in email.

8. The system for verifying the line information in a layout as claimed in claim 5, wherein the data update unit is used for further updating the line data in the line information database according to the modified line information record file.
